(19) United States
(12) Patent Application Publication
(10) Pub. No.: US 2011/0047217 A1
(43) Pub. Date: Feb. 24, 2011

(54) Real Time Collaborative Three Dimensional Asset Management System

(76) Inventors: Remi S. Arnaud, Menlo Park, CA (US); Khaled Mammou, Santa Clara, CA (US)

Correspondence Address: TROP, PRUNER & HU, P.C., 1616 S. VOSS RD., SUITE 750, HOUSTON, TX, 77057-2631, US

(21) Appl. No.: 12/542,837

(22) Filed: Aug. 18, 2009

(51) Int. Cl. G06F 15/16

(52) U.S. Cl. 709/205

(57) ABSTRACT

In some embodiments, real time collaborative asset management may be provided for computer graphics. This may be implemented using a server proxy between an asset server and client applications. The server proxy enables real time collaborative asset management. The server may include a compare function which identifies the differences between an asset as originally positioned and as modified. As a result, the server may only communicate the modifications to reduce bandwidth in some embodiments. In addition, by enabling requests to be converted into a common language format, disparate clients may be able to communicate with each through the server.

### BACKGROUND

This relates generally to the management of three dimensional assets. Examples of three dimensional assets include elements of video games and computer generated imagery.

Generally, in connection with video games and computer generated imagery, content involves large numbers of individual contributors. For example, three dimensional modeling artists, sound effect technicians, and developers may all contribute to the characteristics of one particular asset.

The complexity of the development process may be reflected by content creation pipeline architectures that consist of several interconnected heterogeneous subsystems, including digital content creation tools, data optimization and processing modules, and compression components. These subsystems transform the production team inputs into a set of digital assets.

### BRIEF DESCRIPTION OF THE DRAWINGS

FIG. 1 is a global architecture of an asset management system in accordance with one embodiment;

FIG. 2 is a architecture for the sandbox, shown in FIG. 1, in accordance with one embodiment;

FIG. 3 is a communication mechanism in accordance with one embodiment; and

FIG. 4 is a flow chart for one embodiment.

### DETAILED DESCRIPTION

A variety of users may interact with a given asset, such as an element in a video game or computer generated imagery film, using an intercommunication tool. The content pipeline may be composed of heterogeneous digital content creation tools, such as Maya or 3Ds Max, to mention a few examples. Each of these tools may have different open and proprietary formats. Converting the assets, such as three dimensional characters in animations from one format to another, may represent a bottleneck during the production process.

Another issue with enabling multiple user interaction with such assets is data validation. During the production process, assets are constantly inserted, updated, and removed. Efficient detection of input data errors ensures system integrity in some embodiments. Examples of input data errors include corrupt data, missing documents, and incompatibilities between dependent assets.

The creation of the assets may involve collaboration of different team members. Character modelers work with animators who work with audio technicians. Therefore, seamless corroborative editing of different digital assets at any stage of the content creation pipeline is desirable in some embodiments.

Finally, the collaborative editing of the game and film assets may involve the possibility that each user may access assets also being manipulated by other users. Such access may be controlled and managed through well defined user rights management systems in some embodiments.

Tasks such as ensuring approval of submitted updates before integration or keeping track of project status and evaluation may be provided in some embodiments. Error logs may be generated and alerts may be provided as necessary in some embodiments. Automatic generation and management mechanisms for work flow information may be provided in some embodiments.

In one embodiment, a communication protocol and infrastructure provides seamless and transparent communication between different components of a 3D video game/movie content creation pipeline. The system may provide versions control, automatic data validation and error detection, asset dependencies management and manifest generation, and collaborative and real time asset editing, as well as user rights management and work flow information generation and management, in some embodiments.

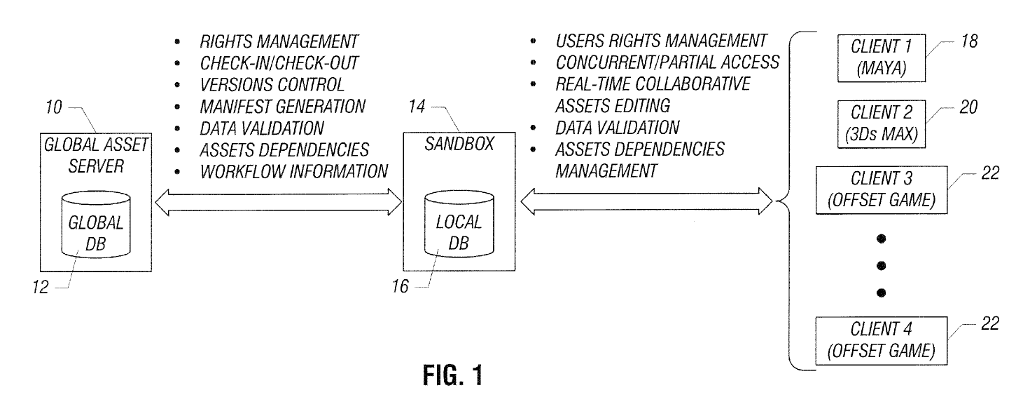

Referring to FIG. 1, the major components may include a global asset server 10 with a global assets database 12. The global asset server 10 is a server application that manages the global assets database 12. The sandbox 14 is a proxy for the server 10. The sandbox 14 may store locally, in local database 16, a subset of global database assets. Once stored in the sandbox 14, these assets may be accessible by the client applications and can be updated concurrently and in real time.

Finally, client applications, such as the applications 18, 20, and 22, consume assets or update those assets.

Thus, the global asset server 10 and the sandbox 14 work together, in some embodiments, to provide rights managements, check in and check out, versions control, manifest generation, data validation, asset dependencies, and work flow information. The sandbox 14 may work together with each application 18, 20, or 22 to provide user rights management, concurrent or partial access, real time collaborative assets, editing, data validation, and assets dependencies management in some embodiments.

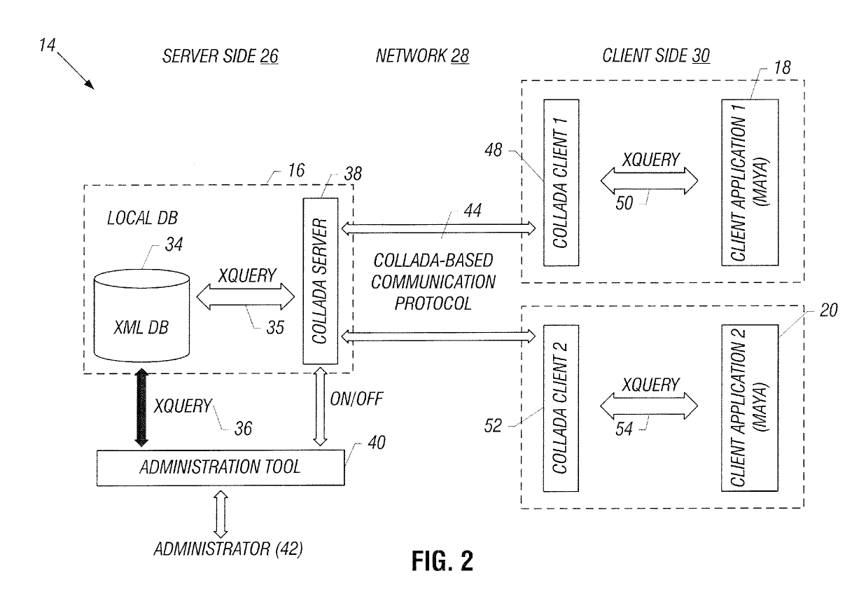

Turning to FIG. 2, the sandbox 14 may include a server side architecture 26, a network 28, and a client side 30. The server side 26 may include an extreme markup language (XML) database 34 within the local database 16. Other languages may also be used. The database 34 contains the three dimensional assets stored in referencing a set of external files for images, videos, and sound assets.

In one embodiment, the three dimensional assets can be stored in accordance with the Collaborative Design Activity (COLLADA) specification. See the COLLADA 1.5 specification (October 2008) available from Khronos Group, Beaverton, Oreg. 97005-2343. The COLLADA specification defines an XML based schema to make it easy to transport 3D assets between applications. This enables diverse 3D authoring and content processing tools to be combined. The intermediate language provides comprehensive encoding of visual schemes.

The COLLADA server 38 handles the client session creation and access to the database 34. The clients 48, 52 on the client side 30, may be middleware managing the communication protocol 44 between the client applications, such as the applications 18 and 20, for example, and the server 10. The administration tool 40 provides the interface to enable an administrator 42 to manage the database 34 and COLLADA server 38 via on/off commands. It may create and delete users in user groups, manage user's rights, upload, delete, or update documents and the like.

Overall, the sandbox provides real time collaborative update and editing of three dimensional assets. This makes it possible for several clients to access the same 3D scenes concurrently and to update those scenes using different client applications. The communication between the client application and the server 10 through the server 38 through the client 48 may be totally transparent to the user in some embodiments. Moreover, any update applied by a user may be visible in real time to all of the other users.

Messages between the client applications 18 or 20 and the client 48 or 52 may be provided by Xqueries 50 or 54, as indicated, which is an XML query language. See W3C Recommendation, XQuery1.0: An XML Query Language, 23 Jan. 2007, available from the Worldwide Web Consortium (W3C), through MIT, 32 Vassar Street, Room 32-4575, Cambridge, Mass. 02139. Likewise, an Xquery 36 may be passed between the administrator tool 40 and database 34 or an Xquery 35 may be provided between server 38 and database 34.

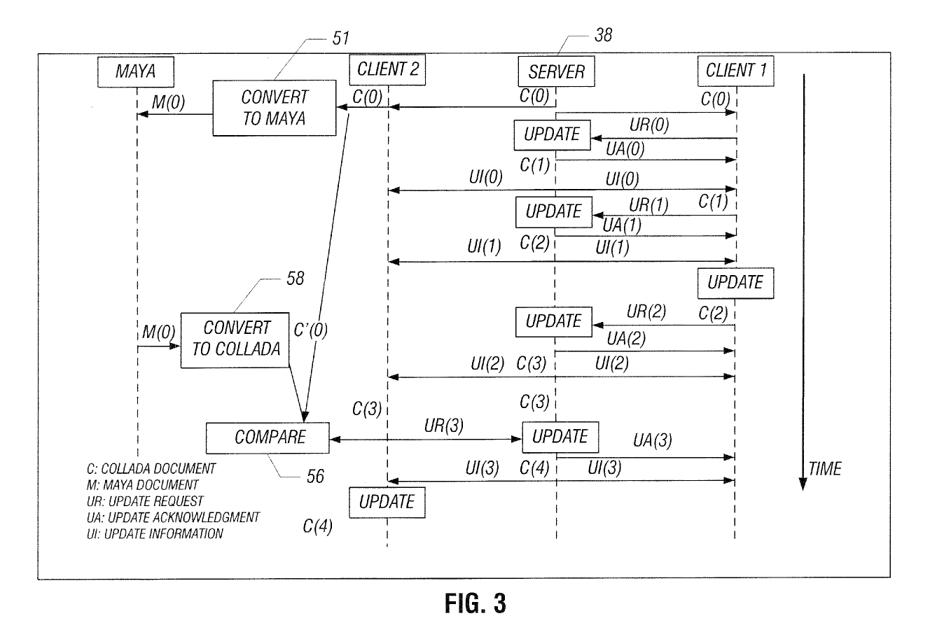

Moving to FIG. 3, in an embodiment with a sandbox and two clients, the client 2 interacts with the client 18 application Maya. To simplify the depiction, the communication between the client 1 and its client application is not represented.

In the illustrated scenario, first client 1 and client 2 both retrieve the version C(0) of a COLLADA document. The client 2 sends version C(0) to the Maya application which, in turn, handles the conversion 51 from the COLLADA format to the Maya scene representation. Such conversions are well known. The client 1 then sends an update response zero (UR(0)) to the COLLADA server 38 as a set of Xquery queries. The server 38 applies the client request and tests the validity and the coherency of the resulting documents and all documents referencing it. Thus, the server keeps track of the inter-asset references and automatically updates an asset dependencies graph.

Once the validation is accomplished, an update acknowledgement zero (UA(0)) message is sent to the client 1 to notify the client that the request was subsequently executed (or not). If not, the update acknowledgement message describes the generated errors. If the request was successful, an update information zero (UI(0)) message describes the set of modifications to be applied to version C(0) to obtain the new version C(1). The update information message may be broadcast to all clients in one embodiment.

As illustrated for client 2, only differences between the last received version C(0) and the newly created version C′(0) are sent to the server 38 from the compare function 56. Those updates UR(4) are applied to the last coherent version UR(3) of the server C(3) to create C(4).

The Maya version (M(0)) is converted to COLLADA at conversion function 58 and is compared via COLLADA with the version C′0 at compare function 56. The function 56 sends an update request to update C(3) and to create version C(4) in server 38. Because of the use of conversion, it is possible to determine the differences between versions that may have originated in different languages. Then the server need only know of the change in an asset.

In some cases, conflicts may arise. Two users may seek to make inconsistent changes. In one embodiment, those users are notified of the coherency problem. As an example, if one user seeks to delete an asset, another user seeks to modify, then an incoherency exists.

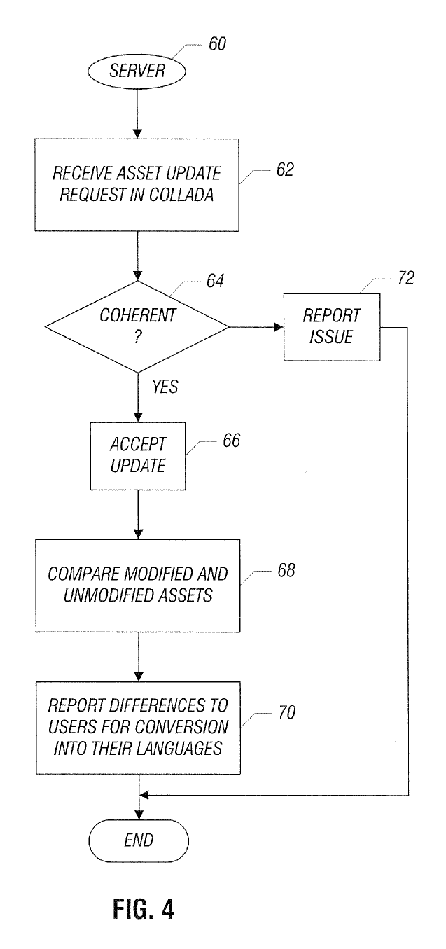

Referring to FIG. 4, in accordance with some embodiments, sequences described herein may be implemented in hardware, software, or firmware. For example, in a software or firmware application, the software may reside within the sandbox 14 or global asset server 10 within a suitable storage or memory within those devices. The memory or storage may be separate from or part of one of the sandbox of global asset server. That memory or storage may store instructions which are executable by a computer.

A sequence which may be implemented by such instructions, in some embodiments, is identified as server sequence 60. Initially, an asset update request is received in COLLADA format, as indicated in block 62. Particularly, the client applications may use a convert function to convert their update request to the COLLADA format or to some other common format. Then a check at diamond 64 determines whether or not two or more concurrently received requests are coherent. If not, an issue may be reported, as indicated in block 72.

Otherwise, the update request may be accepted, as indicated in block 66. Then the update request is compared (block 68) to a prior version of the asset and only the changes or differences between the prior version of the asset and the updated asset are reported, as indicated in block 70.

One benefit of converting a variety of inputs to a common format, such as COLLADA, and for converting outputs back to disparate formats is that such conversion makes collaborative asset management more efficient. One benefit of the compare function 56 is that by only conveying differences between a prior version and a current version, bandwidth may be conserved. In effect, clients may only provide differences, in some cases, and the server may respond, only with differences, conserving bandwidth in both directions. Because of the conversion function 51 or 58, transparent communications may be made with disparate third party tools in some embodiments.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
providing real time collaborative asset management for computer graphics; and
providing a server proxy between an asset server and client applications, said server proxy to enable real time collaborative asset management.

2. The method of claim 1 including enabling transparent communication with third party tools by receiving inputs converted into a common language.

3. The method of claim 1 including providing a database associated with said server for a plurality of assets used by a plurality of clients.

4. The method of claim 1 including enabling a communication protocol between client applications and the server wherein two clients can attempt to modify the same asset at the same time.

5. The method of claim 4 including enabling clients to send requests to update an asset to the server.

6. The method of claim 5 including enabling the server to test the validity of a client request.

7. The method of claim 6 including enabling the server to ensure the coherency of the result of the asset resulting from the client request to update the asset, as well as all documents representing the updated asset.

8. The method of claim 7 including maintaining a graph of the dependencies of each asset on any other asset.

9. The method of claim 8 including maintaining a list of references between assets.

10. The method of claim 9 including providing a notification describing each modification applied to an asset to all clients, by only describing the difference between the modified asset and the unmodified asset.

11. An apparatus comprising:
an asset server;
a server proxy being between said asset server and client applications, said proxy server to enable real time collaborative asset management; and
said asset server to receive asset update requests in a common language format, said server further including a compare function to determine the difference between an asset before being modified and after being modified and to transmit only the changes in the asset, instead of the entire asset.

12. The apparatus of claim 11 wherein apparatus to receive requests to update graphics assets in a common language format.

13. The apparatus of claim 11 including a database associated with said server for a plurality of assets used by a plurality of clients.

14. The apparatus of claim 11, said asset server to enable two different client applications to attempt to modify the same graphics asset at the same time.

15. The apparatus of claim 14, said server to enable clients to send requests to update an asset to the server for the server to test the validity of such a client request.

16. The apparatus of claim 15, said server to ensure coherency of the result of any asset modification.

17. The apparatus of claim 16, said server to maintain the graphic dependencies of each asset based on any other asset.

18. The apparatus of claim 17, said server to maintain a list of references between assets.

19. The apparatus of claim 18, said server to notify all the client applications of a change of any asset.

20. The apparatus of claim 19 wherein said server to notify the clients of only the differences between the original asset and the modified asset.

21. A computer readable medium storing instructions executed by a computer to:
provide real time collaborative graphics asset management; and
handle update requests for graphics assets from clients using different software languages by receiving those update requests in a common language.

22. The medium of claim 21 further storing instructions to provide reports of update requests to a plurality of clients.

23. The medium of claim 22 further storing instructions to report only the update to the asset and not the portions of the asset that are unchanged.

24. The medium of claim 21 further storing instructions to keep track of dependencies between graphics assets.

25. The medium of claim 24 further storing instructions to maintain a list of references between assets.
